(19) United States
(12) Patent Application Publication
(10) Pub. No.: US 2013/0108359 A1
(43) Pub. Date: May 2, 2013

(54) HIGH TORQUE MOTOR KEY

(71) Applicant: Marc Kyle, Lawton, OK (US)

(72) Inventor: Marc Kyle, Lawton, OK (US)

(21) Appl. No.: 13/287,414

(22) Filed: Nov. 2, 2011

(51) Int. Cl. F16D 1/06

(52) U.S. Cl. 403/351

(57) ABSTRACT

Tire making machines and driven assemblies for use in a tire making machine. The driven assembly includes a motor having a drive shaft. The drive shaft extends along a length and has a keyway extending along a portion of the length. The keyway includes a bottom surface, sidewalls, and a ramp surface. The driven assembly also includes a driven hub operatively connected to the drive shaft and having a hub keyway. A key is received in the keyway and the hub keyway for operatively connecting the drive shaft and the driven hub. The key includes a bottom surface, side surfaces, and a curved surface. The curved surface and ramp surface include transverse sections having a curved profile, and the curved surface fits into the ramp surface.

### TECHNICAL FIELD

This invention relates to key and keyway assemblies for coupling components for the transmission of torque, and more particularly to a driven assembly used in a tire-making machine and having a key and keyway assembly.

### BACKGROUND

Transmitting torque between a driving device and a driven component in a mechanical system may be accomplished by way of a key and keyway assembly. In a well-known design, a keyway is provided in the output or drive shaft of a motor, which is the driving device. The driven component also includes a keyway. The drive shaft and the driven component are operatively coupled at the respective keyways by a key that has a shape generally corresponding to the shapes of the keyways. In such an arrangement, the driven component is commonly referred to as being “keyed” to the drive shaft of the motor. While the construction of such keys may vary, in one example, a key is cut to a desired length from bar stock having chosen size characteristics. A key cut from bar stock has a generally cuboid shape, which is a square or rectangle extruded along a length. In addition to having a shape that is generally complementary to associated keyways, keys can also provide a planar surface that may be engaged by a set screw in the driven component. Such an arrangement strengthens the connection between the driven component and the drive shaft.

Through operation of the mechanical system, stress concentrated at the keyways can cause a material failure of either the driving device or the driven component. It is desirable to decrease the occurrence of such material failures by decreasing the amount of concentrated stress present within the keyways. By decreasing the concentrated stress, the mechanical system benefits from a longer useful life, decreased costs of repair, and reduced downtime for maintenance. Keys and keyways designed to decrease stress concentrations have been developed and generally include designs of varying complexity including ramps, fillets, chamfers, rounds and other geometries for reducing stress concentrations.

While keyways and keys have been designed to reduce stress concentrations, some of these designs have been to the detriment of the connection between the driven component and the shaft. More specifically, in the case of a pulley hub mounted on the drive shaft of a motor, the key positioned in the keyway should not only have a shape that transmits torque, but should also provide a generally planar surface for engagement by a set screw in the pulley hub. Proper installation of the set screw requires such a generally planar surface to firmly connect the pulley hub to the drive shaft. However, keyways designed with complex, stress-concentration-reducing features may include geometries that are incompatible with traditional keys, thereby frustrating the need for providing a generally planar surface for engagement by a set screw. For example, keyways having an arcuate ramp near an end of the keyway to reduce stress concentrations may fail to accommodate the cuboid shape of a standard key along the entire length of the keyway. In such a case, a planar surface will not be provided along the entire length of the keyway. If a set screw hole in an associated pulley hub is not directly above a planar surface, the set screw could partially or completely fail to engage the key. Failure to properly engage the key with the set screw may result in a loose pulley hub, or may cause increased stress in portions of the key or keyway, possibly leading to decreased performance or premature failure of the connection between the pulley hub and the drive shaft. Operators of these mechanical systems have been forced to choose between properly mounted set screws or keys and keyways having desirable stress-reducing designs.

For the foregoing reasons, there is a need for a key and keyway assembly that couples a driving device and a driven component, while allowing an operator to use designs of keys or keyways that provide stress-reducing advantages.

### SUMMARY OF THE INVENTION

According an embodiment of the invention, a tire making machine includes a motor including a drive shaft. The drive shaft includes a keyway having a keyway bottom surface extending along a longitudinal direction, and the keyway bottom surface includes a substantially planar portion and an arcuate ramp portion. The tire making machine also includes a driven member coupled to the drive shaft for rotation therewith and a key configured to seat in the keyway to operatively couple the motor and the driven member. The key includes opposed side surfaces and a bottom surface extending between the opposed side surfaces and having a substantially planar segment and a curved surface segment. The curved surface segment includes rounded edges where it intersects the opposed side surfaces. When the key is seated in the keyway, the bottom surface of the key is coextensive with the keyway bottom surface along the longitudinal direction such that the curved surface segment engages the arcuate ramp portion and the substantially planar segment engages the substantially planar portion.

A tire making machine, as above, may be provided, wherein the drive shaft includes a proximal end and a distal end opposite the proximal end. The keyway defines a groove initiating at the arcuate ramp portion and extending along the drive shaft in the longitudinal direction to the distal end.

A tire making machine, having any of the above features, may be provided, wherein the driven member includes a hub having a set screw, the set screw engaging the key to couple the drive shaft and the hub. The key includes a generally planar top surface on which the set screw engages the key when the key is seated in the keyway. In some embodiments, the set screw engages the top surface of the key in an area generally above the curved surface.

A tire making machine, having any of the above features, may be provided, wherein the key includes a substantially planar end oriented generally normal to the substantially planar segment of the bottom surface, the substantially planar end being located adjacent the distal end of the drive shaft when the key is seated in the keyway.

In other aspects of the invention, a driven assembly for use in a tire making machine includes a motor having a drive shaft. The drive shaft extends along a length and has a keyway extending along a portion of the length. The keyway includes a bottom surface, sidewalls, and a ramp surface. The driven assembly also includes a driven hub operatively connected to the drive shaft and having a hub keyway. A key is received in the keyway and the hub keyway for operatively connecting the drive shaft and the driven hub. The key includes a bottom surface, side surfaces, and a curved surface. The curved surface and ramp surface include transverse sections having a curved profile, and the curved surface fits into the ramp surface.

A driven assembly, as above, may be provided, wherein the key includes a top surface and the driven hub includes a set screw hole and a set screw therein and the set screw engages the top surface of the key. In some embodiments, the set screw engages the top surface of the key in an area generally above the curved surface.

A driven assembly, having any of the above features, may be provided, wherein the key extends along the portion of the length of the drive shaft having the keyway.

### BRIEF DESCRIPTION OF THE DRAWINGS

The accompanying drawings, which are incorporated in and constitute a part of this specification, illustrate embodiments of the invention and, together with the general description given above and the detailed description of the embodiments given below, serve to explain the principles of the invention. In the figures, corresponding or like numbers or characters indicate corresponding or like structures.

FIG. 1 is a schematic perspective view of one embodiment of a driven assembly situated in the environment of a tire making machine.

FIG. 2 is a cross-sectional side view taken along line 2-2 of FIG. 1 of a driven hub operatively connected to a drive shaft of a motor by way of a key and keyway assembly.

FIG. 3A is a disassembled perspective view of the drive shaft and key of FIG. 2 before the key is situated into the keyway on the drive shaft.

FIG. 3B is a perspective view of the drive shaft and key of FIGS. 2 and 3A with the key situated in the keyway on the drive shaft.

FIG. 4 is a bottom perspective view of a key constructed according to the concepts disclosed herein, such as the key of FIGS. 1-3B.

FIG. 5 is a side elevation view of the key of FIG. 4.

FIG. 6 is a bottom plan view of the key of FIGS. 4 and 5.

FIG. 7 is a cross-sectional side view depicting an arrangement where a set screw in a driven hub does not properly engage the key.

### DETAILED DESCRIPTION

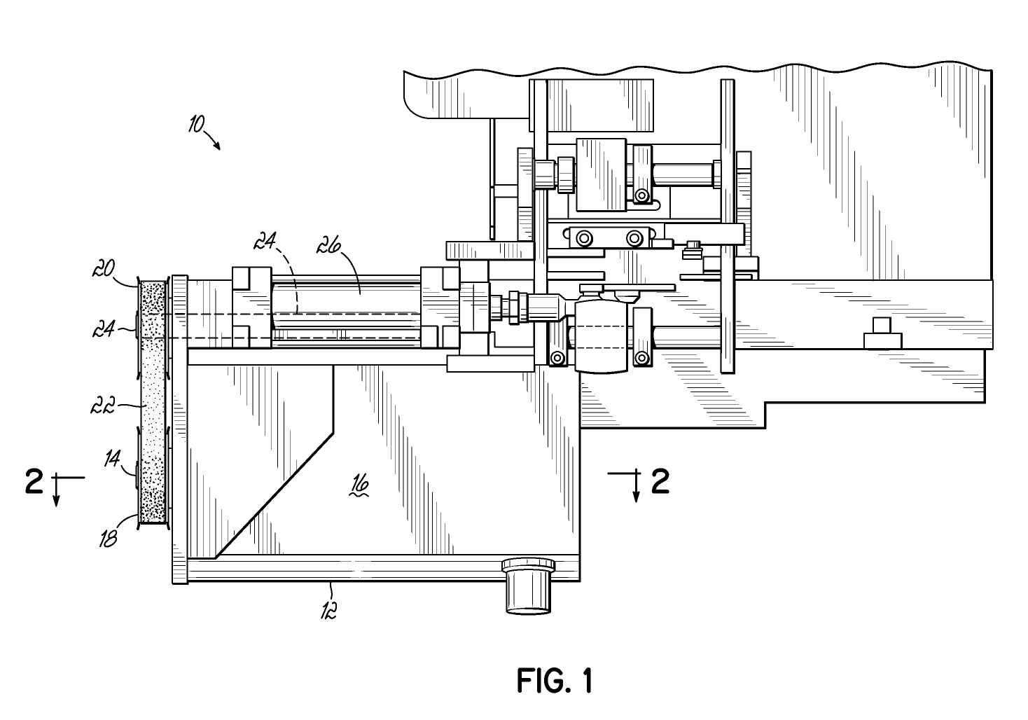

Referring to FIG. 1, a driven assembly is shown and is generally indicated by the numeral 10. The driven assembly 10 is depicted in the context of its use in a portion of a tire making machine, though the teachings contained herein may also be applicable to other technology areas. The driven assembly 10 generally includes a high torque rotary motor 12 having a drive shaft 14. In the figure, the motor 12 is contained within a housing 16. The drive shaft 14 is operatively, or rotationally, coupled to a driven hub 18, which in turn, is operatively coupled to an idler hub 20 by way of a belt 22. The idler hub 20 is operatively coupled to an idler shaft 24 contained within another housing 26. Thus, rotation of the drive shaft 14 is transmitted through the hubs 18, 20 and the belt 22 to produce rotation of the idler shaft 24.

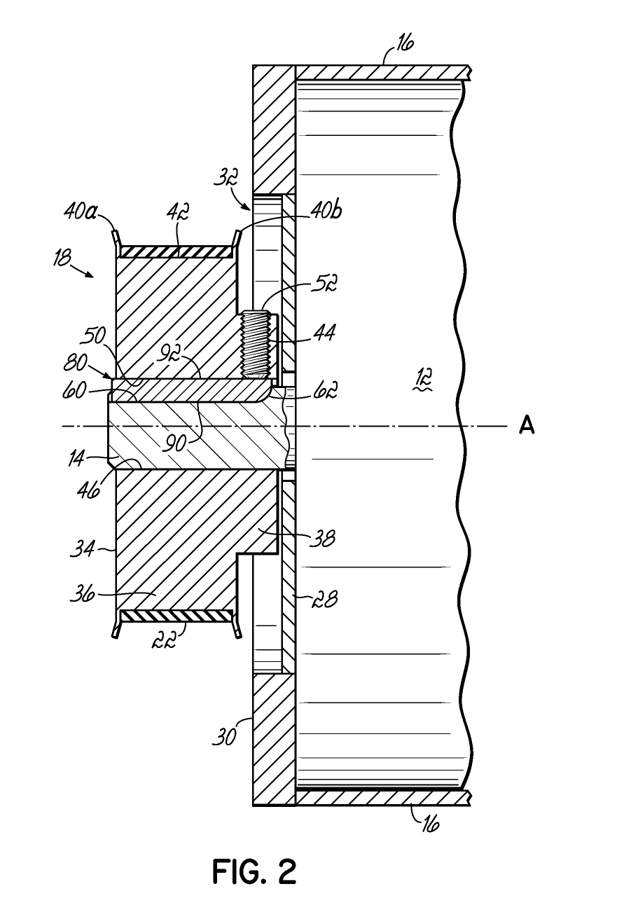

With reference to FIG. 2, the relationship between the motor 12, the drive shaft 14 and the driven hub 18 is shown in greater detail. Particularly, the drive shaft 14 extends out of the housing 16 and through a cover plate 28. A rim 30 extends from the housing 16 and surrounds the cover plate 28 and the drive shaft 14. A bore 32 is defined generally inside the rim 30 and is bounded on one side by the cover plate 28.

The driven hub 18 is in the form of a pulley hub and generally includes a cylindrical-shaped body 34 having a pulley portion 36 and a reduced diameter neck portion 38. The pulley portion 36 includes splayed flanges 40a and 40b projecting radially and axially outwardly that define an annular groove 42 between them, and the belt 22 (FIG. 1) may be received in the groove 42. A set screw aperture 44 extends radially through the neck portion 38.

A through-bore 46 extends through the body 34 in an axial direction (such as along axis A, which represents the rotational axis of the drive shaft 14 and is perpendicular to the radial direction of the cylindrical body). A keyway notch 50 extends along the through-bore 46 and radially further into the body 34. While referred to as a keyway notch, the keyway notch 50 is a keyway and the name used herein was chosen to easily distinguish it from a keyway 60 formed in the drive shaft 14, which is discussed in further detail below.

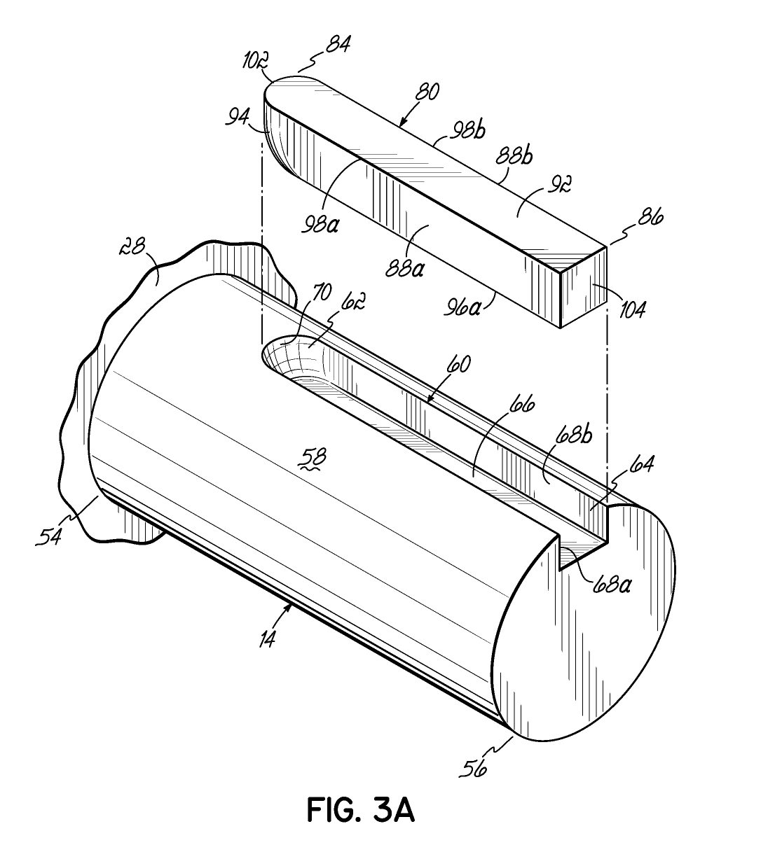

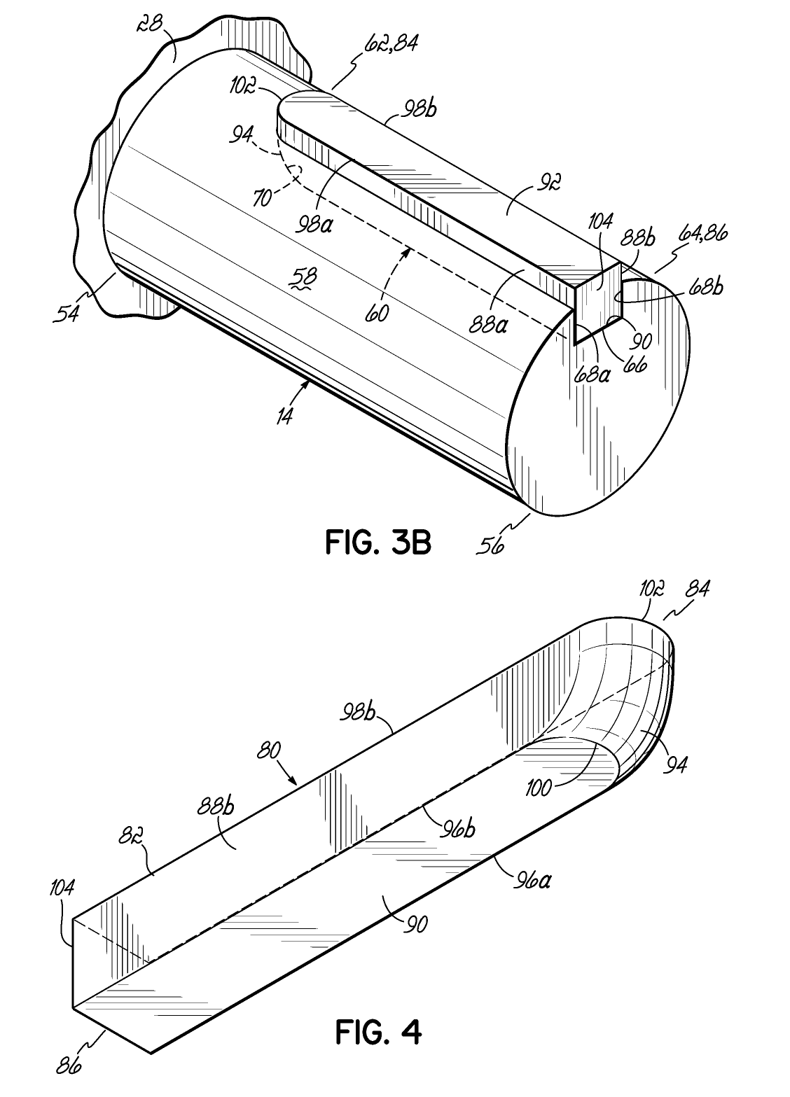

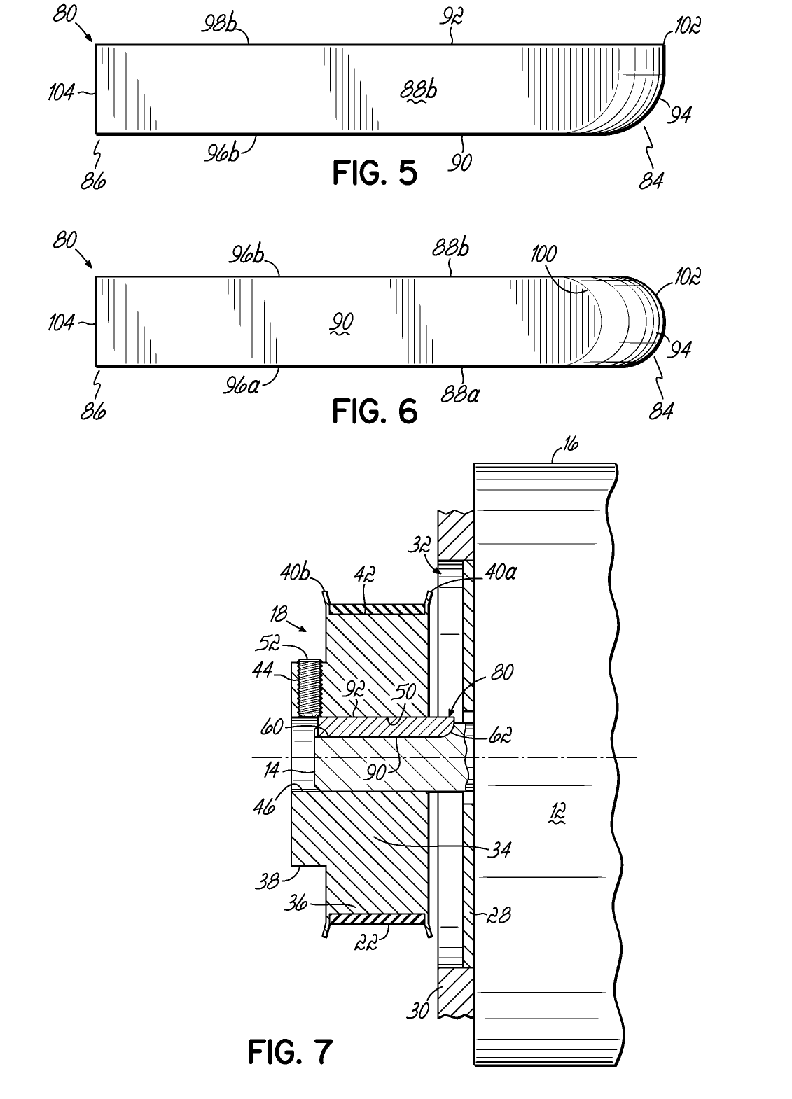

The drive shaft 14 extends through the through-bore 46 of the driven hub 18, with only a very small portion of the drive shaft 14 extending beyond the body 34 of the hub 18. The drive shaft 14 includes an axially-extending keyway 60, the features of which will be described more fully below with reference to FIGS. 3A and 3B. A key 80 is received in the keyway 60 of the drive shaft 14 and in the keyway notch 50 of the driven hub 18. The features of the key 80 will be described more fully below with reference to FIGS. 3A, 3B, and 4-7. The combination of the key 80, the keyway 60, and the keyway notch 50 is a key and keyway assembly, and the interaction of the key 80, the keyway 60, and the keyway notch 50 resists radial movement of the driven hub 18 with respect to the drive shaft 14 and allows for torque applied to the drive shaft 14 to be transferred to the driven hub 18. Thus, in the arrangement shown in FIG. 2, the drive shaft 14 is operatively coupled with the driven hub 18.

In the embodiment shown in FIG. 2, the neck portion 38 is located between the cover plate 28 and the pulley portion 36, so that the neck portion 38 is partially received within the bore 32. A set screw 52 extends through the set screw aperture 44 in the driven hub 18 and engages the key 80 below the aperture 44, thereby resisting axial movement of the driven hub 18 with respect to the drive shaft 14. In this arrangement, the groove 42 of the driven hub 18 is maintained near the rim 30 extending from the housing 16, with the flange 40b being positioned just axially beyond the extent of the rim 30. Thus, the pulley portion 36 may be positioned in close proximity to the housing 16 containing the motor 12. As will be discussed below with reference to FIG. 7, this arrangement of the driven hub 18 with the neck portion 38 between the cover plate 28 and the pulley portion 36 may be the only feasible option for coupling the driven hub 18 with the drive shaft 14.

Turning to FIGS. 3A and 3B, the features of the drive shaft 14 and the keyway 60 are further described. The drive shaft 14 has a generally cylindrical shape and extends axially along a length between a proximal end 54 (near where the drive shaft 14 extends from the cover plate 28 on the housing 16) and a distal end 56. The drive shaft 14 includes a circumferential shaft surface 58.

The keyway 60 is in the form of an axially-extending slot cut below the shaft surface 58, and is situated in the drive shaft 14 between the proximal end 54 and the distal end 56. In the embodiment shown, the keyway 60 extends from a first end or lock end 62 to a second end 64, which is at the distal end 56 of the drive shaft 14. The keyway 60 includes a bottom surface 66 and sidewalls 68a and 68b that extend from the bottom surface 66 to the shaft surface 58. The keyway 60 further includes an arcuate ramp portion or surface 70 in the vicinity of the lock end 62. The bottom surface 66 and the sidewalls 68a and 68b generally include planar portions generally perpendicular to each other, except in the vicinity of the ramp surface 70 and the lock end 62.

At the ramp surface 70, the bottom surface 66 and the sidewalls 68a and 68b merge into a smooth and continuous arcuate ramp up to the shaft surface 58. In particular, the ramp surface 70 is concave and includes curvature in three dimensions. It is shaped so that its transverse sections have a curved profile opening upward out of the keyway 60, with gradual shallowing occurring between the bottom surface 66 and the shaft surface 58. The transverse section curvature profile may be any smooth and continuous arcuate shape, such as the generally circular curvature profile shown.

The shape of the keyway 60 generally corresponds with at least part of the shape of the key 80, and reference may be made to the description of the key 80 for a further understanding of the keyway 60. As shown in FIG. 3B, the keyway 60 and the key 80 are designed so the key 80 fits completely within the keyway 60, including adjacent to the lock end 62 and the ramp surface 70. A portion of the key 80 extends above the shaft surface 58, and this portion is what is received in the keyway notch 50 of the driven hub 18.

Referring now to FIGS. 4-6, the key 80 is shown and generally includes a solid body 82. The body 82 extends axially from a first end or key end 84 to a second end 86, and includes side surfaces 88a and 88b, a bottom surface 90, a top surface 92, and a curved surface 94 near the key end 84.

The side surfaces 88a and 88b intersect with the bottom surface 90 at edges 96a and 96b, respectively. Similarly, the side surfaces 88a and 88b intersect with the top surface 92 at edges 98a and 98b, respectively. The bottom surface 90 includes an arcuate edge 100 connecting the edges 96a and 96b. The arcuate edge 100 has a smooth continuous arcuate shape and is concave opening toward the bottom surface 90. In a similar manner, the top surface 92 includes an arcuate edge 102 connecting the edges 98a and 98b, and the arcuate edge 102 has a smooth continuous arcuate shape and is concave opening toward the top surface 92. The arcuate edge 102 of the top surface 92 extends axially beyond the arcuate edge 100 of the bottom surface 90, and the curved surface 94 extends between the arcuate edges 100, 102. Both the bottom surface 90 and the top surface 92 have substantially or generally planar portions, which may also be referred to as segments, and the curved surface 94 extends up from the bottom surface 90 to the top surface 92. In the embodiments shown, the key 80 includes a substantially planar or flat surface 104 at the second end 86.

Much of the body 82 has a cuboid shape, so that transverse sections of portions of the body 82 will have a square or rectangular shape. However, the shape of the body 82 changes near the key end 84. Particularly, the portion of the body 82 near the key end 84 has a shape corresponding with the keyway 60 so that the key end 84 completely mates with the lock end 62. Accordingly, the curved surface 94 has a partial ovoid shape (egg shape) or partial spherical shape so that transverse sections of the body 82 have a curved profile opening upward, with gradual shallowing occurring between the bottom surface 90 and the top surface 92. The transverse section curvature profile may be any smooth and continuous arcuate shape, such as the generally circular curvature profile shown, and should be chosen to match the curvature features of the ramp surface 70 of the keyway 60 so that the curved surface 94 fits completely into the ramp surface 70, the shape of each complementing the other, whereby the key end 84 of the key 80 mates with the lock end 62 of the keyway 60.

In some embodiments, the key 80 is composed of steel. In these or other embodiments, the key 80 may be zinc plated. In some embodiments, the arcuate edges 100, 102 have a radius of curvature of between approximately 2 mm and approximately 5 mm. And in some embodiments, the ramp surface 70 and the curved surface 94 have a radius of curvature along the length direction of the keyway 60 and the key 80, respectively, of approximately 3.45 mm.

Returning to FIGS. 3A and 3B, the key 80 fits in the keyway 60 so that the key end 84 mates with the lock end 62, and the curved surface 94 of the key 80 is directly adjacent the ramp surface 70 of the keyway 60. The side surfaces 88a and 88b of the key 80 are directly adjacent the sidewalls 68a and 68b of the keyway 60, respectively, and the bottom surface 90 of the key 80 is directly adjacent the bottom surface 66 of the keyway 60. The top surface 92 of the key 80 is exposed out of the keyway 60, and a portion of the side surfaces 88a and 88b of the key 80 extend out of the keyway 60 beyond the shaft surface 58.

As shown, the key 80 fills the entire keyway 60, with the key end 84 of the key 80 and the lock end 62 of the keyway 60 aligned, and the second end 86 of the key 80 being flush with the distal end 56 of the drive shaft 14. Thus, the entire length of the keyway 60 includes at least a portion of the key 80. Alternative key lengths could be conceived so that a key is shorter or longer than an associated keyway, and so that the end of the key opposite the key end falls short of or extends beyond the distal end of a drive shaft. In any case, the key end of the key and the lock end of the keyway are aligned.

In the arrangement depicted in FIG. 2, the driven hub 18 is positioned on the drive shaft 14 so that the set screw aperture 44 is generally adjacent the lock end 62 of the keyway 60. Since the key 80 extends into this portion of the keyway 60, in particular in the region of the curved surface 94, the top surface 92 of the key 80 provides the generally planar surface for the set screw 52 to engage. Thus, the set screw 52 engages the top surface 92 in an area generally above the curved surface 94 or the ramp surface 70.

As mentioned, and with reference to FIG. 2, the portion of the key 80 that extends out of the keyway 60 beyond the shaft surface 58 is received within the keyway notch 50 of the driven hub 18. Thereby, the key 80 is received in both the keyway 60 and the keyway notch 50, and the drive shaft 14 may be operatively coupled to the driven hub 18 by this key and keyway assembly.

FIG. 7 illustrates that for some drive shaft and driven hub combinations, the arrangement shown in FIG. 2 may be the only feasible arrangement for coupling the driven hub 18 with the drive shaft 14. In particular, FIG. 2 shows the neck portion 38 located between the cover plate 28 and the pulley portion 36. The set screw 52 engages the top surface 92 of the key 80, and this engagement helps secure the hub 18 with respect to the drive shaft 14. The interaction of the disclosed key 80 and the keyway 60 provides a key surface for the set screw 52 to engage in an area generally above the curved surface 94 or the ramp surface 70. The driven hub 18 could not be installed onto the drive shaft 14 in the flipped arrangement shown in FIG. 7 because in that case there is little or no key surface for the set screw 52 to engage. Thus, the set screw 52 does not properly engage the key 80. Again, engagement between the set screw 52 and the key 80 provide important advantages for preventing axial movement of the driven hub 18 with respect to the drive shaft 14, and configurations where a set screw can engage a key are preferable.

Features for reducing stress concentrations in the keyway notch 50, the keyway 60 or the key 80 may be provided in the driven assembly 10. In particular, it is believed that the shape of the keyway 60, including the ramp surface 70, may provide stress reducing features. Similarly, it is also believed that the shape of the key 80, including the curved surface 94, may provide stress reducing features. Thus, the driven assembly 10 may include the advantages provided by keyways and keys that are designed to reduce stress concentrations, while at the same time providing a planar surface for a set screw to engage.

Torque generated by the motor 12 is transmitted in the driven assembly 10 as follows, with reference being made to the general features shown in FIG. 1. Again, FIG. 1 depicts the driven assembly 10 in relation to components of a tire making machine. The motor 12 includes a drive shaft 14, which is operatively connected to the driven hub 18 by way of the key and keyway assembly provided by the interaction of the key 80 with the keyway 60 in the drive shaft 14 and the keyway notch 50 in the driven hub 18. Thus, when the drive shaft 14 rotates, the driven hub 18 rotates, making the drive shaft 14 rotationally coupled to the driven hub 18. The driven hub 18, in turn, is operatively connected to the idler hub 20 by way of the belt 22. As the driven hub 18 rotates, the belt 22 moves in the groove 42 of the driven hub 18, and this movement in the belt 22 is translated to the idler hub 20, causing the idler hub 20 to rotate. The idler hub 20, in turn, is operatively connected (either directly or indirectly) to the idler shaft 24, and rotation of the idler hub 20 is translated into rotation of the idler shaft 24. Thus, rotation of the drive shaft 14 actuates rotation of the idler shaft 24, which is located at a distance from the motor 12.

While the invention has been illustrated by the description of embodiments thereof, and while the embodiments have been described in considerable detail, it is not intended to restrict or in any way limit the scope of the appended claims to such detail. Additional advantages and modifications will readily appear to those skilled in the art. Therefore, the invention in its broadest aspects is not limited to the specific details shown and described. The various features disclosed herein may be used in any combination necessary or desired for a particular application. Consequently, departures may be made from the details described herein without departing from the spirit and scope of the claims which follow.

What is claimed is:

1. A tire making machine comprising:
a motor including a drive shaft, the drive shaft including a keyway having a keyway bottom surface extending along a longitudinal direction, the keyway bottom surface including a substantially planar portion and an arcuate ramp portion;
a driven member coupled to the drive shaft for rotation therewith; and
a key configured to seat in the keyway to operatively couple the motor and the driven member, the key including opposed side surfaces and a bottom surface extending between the opposed side surfaces and having a substantially planar segment and a curved surface segment, the curved surface segment having rounded edges where it intersects the opposed side surfaces;
wherein when the key is seated in the keyway, the bottom surface of the key is coextensive with the keyway bottom surface along the longitudinal direction such that the curved surface segment engages the arcuate ramp portion and the substantially planar segment engages the substantially planar portion.

2. The tire making machine of claim 1, wherein the drive shaft further includes;
a proximal end; and
a distal end, the distal end opposite the proximal end;
wherein the keyway defines a groove initiating at the arcuate ramp portion and extending along the drive shaft in the longitudinal direction to the distal end.

3. The tire making machine of claim 2, wherein the driven member includes a hub having a set screw, the set screw engaging the key for securing the hub with respect to the drive shaft.

4. The tire making machine of claim 3, wherein the key includes a generally planar top surface on which the set screw engages the key when the key is seated in the keyway.

5. The tire making machine of claim 4, wherein the top surface of the key includes a radius of curvature of between approximately 2 mm and approximately 5 mm.

6. The tire making machine of claim 3, wherein the hub is a first pulley hub and the driven member further includes:
a second pulley hub; and
a drive belt operatively connecting the first pulley hub to the second pulley hub;
wherein the drive belt and the second pulley hub are configured to drive a tire assembly component.

7. The tire making machine of claim 3, wherein the key includes a substantially planar end oriented generally normal to the substantially planar segment of the bottom surface, the substantially planar end being located adjacent the distal end of the drive shaft when the key is seated in the keyway.

8. The tire making machine of claim 3, wherein the key includes a substantially planar end oriented generally normal to the substantially planar segment of the bottom surface, the substantially planar end being disposed in a coplanar relationship with the distal end of the drive shaft when the key is seated in the keyway.

9. The tire making machine of claim 1, wherein the arcuate ramp portion includes a radius of curvature of approximately 3.45 mm.

10. The tire making machine of claim 4 wherein the set screw engages the top surface of the key in an area generally above the curved surface segment.

11. The tire making machine of claim 1, wherein the key is composed of steel.

12. The tire making machine of claim 11, wherein the steel is zinc plated.

13. A driven assembly for use in a tire making machine, the driven assembly comprising:
a motor having a drive shaft, the drive shaft extending along a length and having a keyway extending along a portion of the length, the keyway including a bottom surface, sidewalls, and a ramp surface,
a driven hub operatively connected to the drive shaft and having a hub keyway,
and a key received in the keyway and the hub keyway for operatively connecting the drive shaft and the driven hub, the key including a bottom surface, side surfaces, and a curved surface,
wherein the curved surface and the ramp surface each include transverse sections having a curved profile, and
wherein the curved surface fits into the ramp surface.

14. The driven assembly of claim 13, wherein the key includes a top surface and the driven hub includes a set screw hole and a set screw therein and the set screw engages the top surface of the key.

15. The driven assembly of claim 14, wherein the set screw engages the top surface of the key in an area generally above the curved surface.

16. The driven assembly of claim 15, wherein the key extends along the portion of the length of the drive shaft having the keyway.

17. The driven assembly of claim 15, wherein the top surface and bottom surface of the key include arcuate edges, and the curved surface extends between the arcuate edges.

18. The driven assembly of claim 15 further comprising an idler hub operatively connected to the driven hub and an idler shaft operatively connected to the idler hub.
